(19) United States
(12) Patent Application Publication
(10) Pub. No.: US 2019/0242328 A1
(43) Pub. Date: Aug. 8, 2019

(54) Engine Bracket Kit

(71) Applicant: Hasport Performance, Inc., Phoenix, AZ (US)

(72) Inventors: Brian Gillespie, Phoenix, AZ (US); Keith Gillespie, Tempe, AZ (US)

(73) Assignee: Hasport Performance, Inc., Phoenix, AZ (US)

(21) Appl. No.: 15/890,455

(22) Filed: Feb. 7, 2018

(51) Int. Cl. F02F 7/00

(52) U.S. Cl. CPC F02F 7/0082

(57) ABSTRACT

A bracket kit for mounting an engine mount to three different engine blocks. The bracket kit comprises a bracket comprising an upper mounting surface and a hole having a centerline for mounting the engine mount that defines a longitudinal axis. The bracket comprises inner and outer rear mounting surfaces. The bracket comprises first and second holes extending to the inner rear mounting surface. The bracket comprises third and fourth holes extending to the outer rear mounting surface. The inner rear mounting surface is set back from the outer rear mounting surface. The bracket kit comprises a bushing removably engaged with a recessed portion of the first hole for attaching the bracket to the first engine block. The bushing may be removably engaged with a recessed portion of the second hole for attaching the bracket to the second engine block or the third engine block.

### BACKGROUND OF THE INVENTION

Referring to FIGS. 1-3, engine mounts are widely used to mount an engine block to a vehicle such as a car. In many applications, the engine mount is mounted to a bracket that is mounted to the engine block. There are many reasons a customer may want to replace the engine block in his/her vehicle with a different engine block using the same engine mount. FIG. 1 shows a conventional K20A type engine block 12 having holes 14, 16, and 18 for receiving a threaded bolt (not shown) to mounted a conventional bracket (not shown). FIG. 2 shows a conventional K24A type engine block 20 having holes 22, 24, and 26 for receiving a threaded bolt (not shown) to mount a conventional bracket (not shown). FIG. 3 shows a conventional K24Z type engine block 28 having holes 30, 32, and 34 for receiving a threaded bolt (not shown) to mount a conventional bracket (not shown). However, there is no conventional bracket that can be used for all three (3) types of engine blocks.

### SUMMARY OF THE INVENTION

The present invention is a bracket kit for mounting an engine mount to first, second, and third engine blocks of different configurations. The bracket kit comprises a bracket comprising an upper mounting surface and a hole having a centerline for mounting the engine mount that defines a longitudinal axis. The bracket further comprises an inner rear mounting surface and an outer rear mounting surface. The bracket further comprises first and second holes extending to the inner rear mounting surface. The bracket further comprises first and second recessed portions disposed about the first and second holes, respectively. The bracket comprises third and fourth holes extending to the outer rear mounting surface. The inner rear mounting surface is set back from the outer rear mounting surface. The bracket kit further comprises a bushing comprising a hole. The bushing may be removably engaged with the recessed portion of the first hole for attaching the bracket to the first engine block. The bushing may be removably engaged with the recessed portion of the second hole for attaching the bracket to the second engine block or the third engine block.

### BRIEF DESCRIPTION OF THE DRAWINGS

The description of the invention will be more fully understood with reference to the accompanying drawings in which:

FIG. 1 is a side perspective view of a conventional K20A engine block showing three (3) mounting holes for mounting a conventional bracket, and a sensor.

FIG. 2 is a side perspective view of a conventional K24A engine block showing three (3) mounting holes for mounting a conventional bracket.

FIG. 3 is a side perspective view of a conventional K24Z engine block showing three (3) mounting holes for mounting a conventional bracket.

FIG. 4 is a rear exploded view of a bracket kit according to the present invention showing a bracket and spacer.

FIG. 5 is a side perspective view showing the bracket and spacer mounted to the conventional K20A engine block.

FIG. 6 is a side perspective view of the bracket and spacer mounted to the conventional K24A engine block.

FIG. 7 is a side perspective view of the bracket and spacer mounted to the conventional K24Z engine block.

FIG. 8 is a top view of the bracket.

FIG. 9A is a rear view of the bracket showing the mounting hole locations for use with the conventional K20A engine block.

FIG. 9B is a rear view of the bracket showing the mounting hole locations for use with the conventional K24A engine block.

FIG. 9C is a rear view of the bracket showing the mounting hole locations for use with the conventional K24Z engine block.

FIG. 10A is a perspective view of the spacer.

FIG. 10B is a top view of the spacer.

FIG. 10C is a front view of the spacer.

FIG. 10D is a side view of the spacer.

FIG. 11A is a rear perspective view of bracket with the spacer disposed in the first recessed hole of the bracket.

FIG. 11B is a top view of the bracket with the spacer disposed in the first recessed hole of the bracket.

FIG. 12A is a rear perspective view of the bracket with the spacer disposed in the second recessed hole of the bracket.

FIG. 12B is a top view of the bracket with the spacer disposed in the second recessed hole of the bracket.

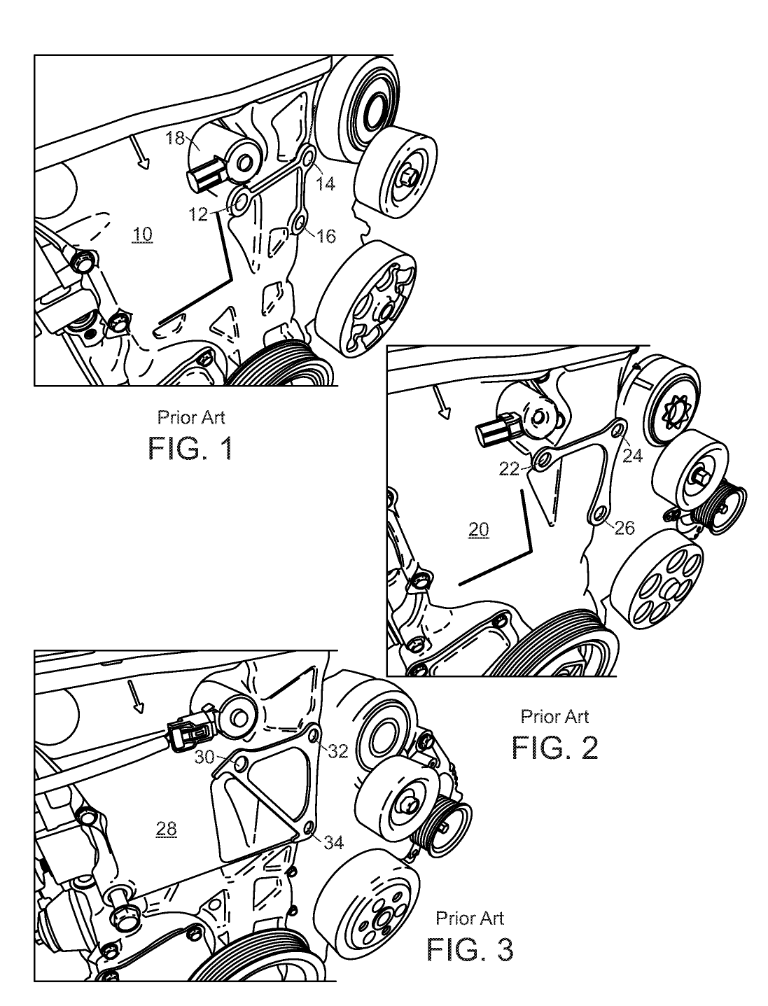

### DESCRIPTION OF THE INVENTION

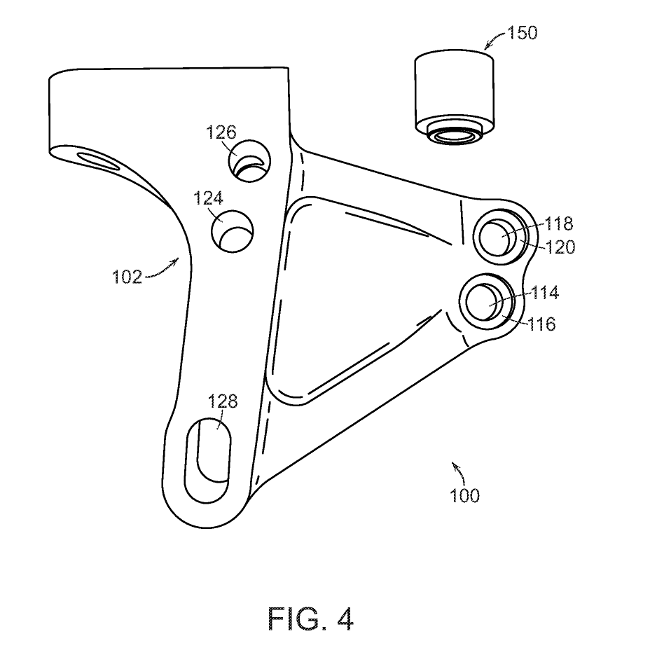

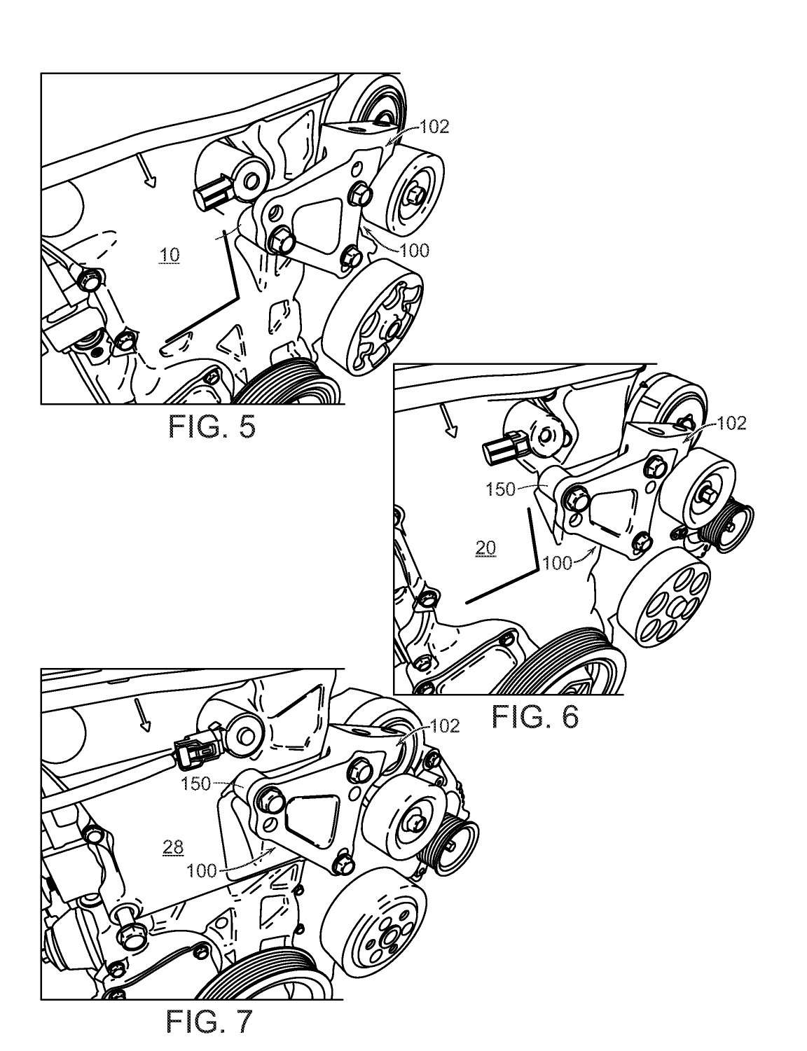

Referring to FIGS. 4-7, the present invention is an engine block bracket kit 100 comprising a bracket 102 and a bushing 150 (FIG. 4). As shown by FIG. 5, in a first application of bracket kit 100, bracket 102 and bushing 150 may be attached or mounted to a conventional K20A type engine block 12 by a plurality of threaded bolts. As shown by FIG. 6, in a second application of bracket kit 100, bracket 102 and bushing 150 may be attached to a conventional K24A type engine block 20 by a plurality of threaded bolts. As shown by FIG. 7, in a third application of bracket kit 100, bracket 102 and bushing 150 may be mounted to conventional K24Z type engine block 28 by a plurality of threaded bolts.

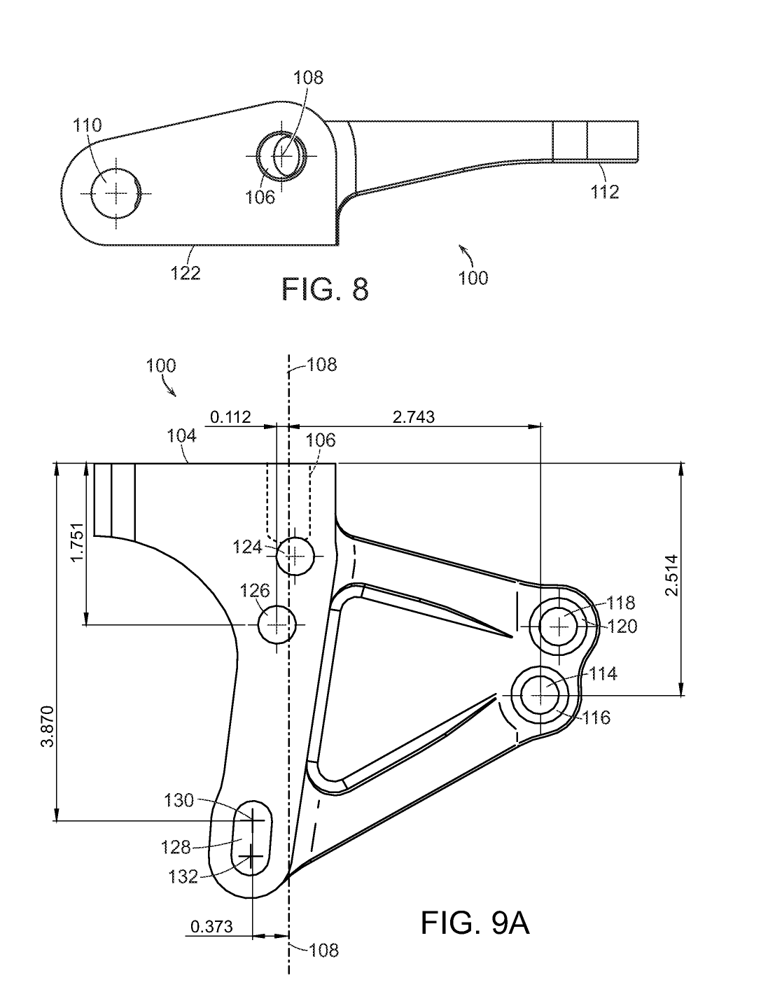

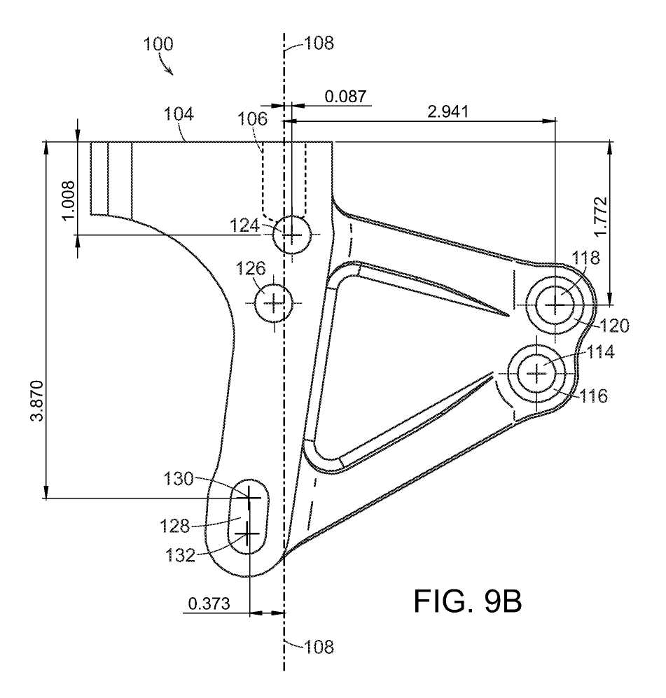

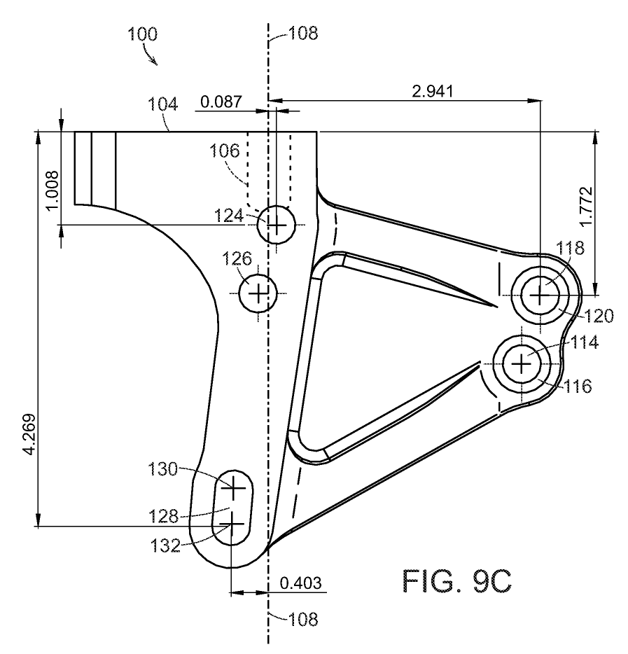

Referring to FIGS. 8 and 9A-9C, bracket 102 comprises an upper mounting surface 104, and mounting holes 106 and 110 extending thru said upper mounting surface 104. Mounting holes 106 and 10 mount an engine mount (not shown) by a plurality of threaded bolts and nuts (not shown). Mounting hole 106 comprises a centerline defining longitudinal axis 108 that, as will be described more fully herein, is used as a reference line for the horizontal location of mounting holes (to be described) for mounting the bracket 102 to engine blocks 12, 20, and 28. Upper mounting surface 104 is used as the reference line for the vertical location of the mounting holes.

With continued referenced to FIGS. 8 and 9A-9C, bracket 102 further comprises an inner rear mounting surface 112. Bracket 102 further comprises a mounting hole 114 extending to inner rear mounting surface 112, and a recessed portion 116 disposed about mounting hole 114. As shown by FIG. 9A, it is critical and necessary to the operation of the present invention that the centerline of mounting hole 114 is positioned in the range of 2.504 to 2.524 (2.514+/−0.010) inches from mounting surface 104 and in the range of 2.733 to 2.753 (2.743+/−0.010) inches from longitudinal axis 108. As will be shown more fully herein, mounting hole 114 is used when bracket 102 is mounted to K20A type engine block 12. Bracket 102 further comprises a mounting hole 118 extending to inner rear mounting surface 112, and a recessed portion 120 disposed about mounting hole 118. As shown by FIG. 9B, it is critical and necessary to the operation of the present invention that the centerline of mounting hole 118 is positioned in the range of 1.762 to 1.782 (1.772+/−0.010) inches from mounting surface 104 and in the range of 2.931 to 2.951 (2.941+/−0.010) inches from longitudinal axis 108. As will be shown more fully herein, mounting hole 118 is used when bracket 102 is mounted to K24A type engine block 20. Mounting hole 114 is disposed in close proximity to mounting hole 118.

With continued referenced to FIGS. 8 and 9A-9C, bracket 102 further comprises an outer rear mounting surface 122. Bracket 102 further comprises a mounting hole 124 extending to outer rear mounting surface 122. As shown by FIG. 9A, it is critical and necessary to the operation of the present invention that the centerline of mounting hole 124 is positioned in the range of 1.741 to 1.761 (1.751+/−0.010) inches from mounting surface 104 and in the range of 0.102 to 0.122 (0.112+/−0.010) inches from longitudinal axis 108. As will be shown more fully herein, mounting hole 124 is used when bracket 102 is mounted to K20A type engine block 12. Bracket 102 further comprises a mounting hole 126 extending to outer rear mounting surface 122. As shown by FIG. 9B, it is critical and necessary to the operation of the present invention that the centerline of mounting hole 126 is positioned in the range of 0.998 to 1.018 (1.008+/−0.010) inches from mounting surface 104 and in the range of 0.077 to 0.097 (0.087+/−0.010) inches from longitudinal axis 108. As will be shown more fully herein, mounting hole 126 is used when bracket 102 is mounted to K24A type engine block 20. Mounting hole 124 is disposed in close proximity to mounting hole 126.

With continued referenced to FIGS. 8 and 9A-9C, bracket 102 further comprises a slotted hole 128 comprising a first axis 130 and a second axis 132. As shown by FIG. 9A, it is critical and necessary to the operation of the present invention that the centerline of first axis 130 of slotted hole 128 is positioned in the range of 3.860 to 3.880 (3.870+/−0.010) inches from mounting surface 104 and in the range of 0.363 to 0.383 (0.373+/−0.010) inches from longitudinal axis 108. As will be shown more fully herein, this position of slotted hole 128 is used when bracket 102 is mounted to K20A engine block 12 and K24A engine block 20. As shown by FIG. 9C, it is critical and necessary to the operation of the present invention that the centerline of second axis 132 of slotted hole 128 is positioned in the range of 4.259 to 4.279 (4.269+/−0.010) inches from mounting surface 104 and in the range of 0.393 to 0.413 (0.403+/−0.010) inches from longitudinal axis 108. As will be shown more fully herein, this position of slotted hole 128 is used when bracket 102 is mounted to K24Z engine block 28. Bracket 102 is made from aluminum by conventional machining operations.

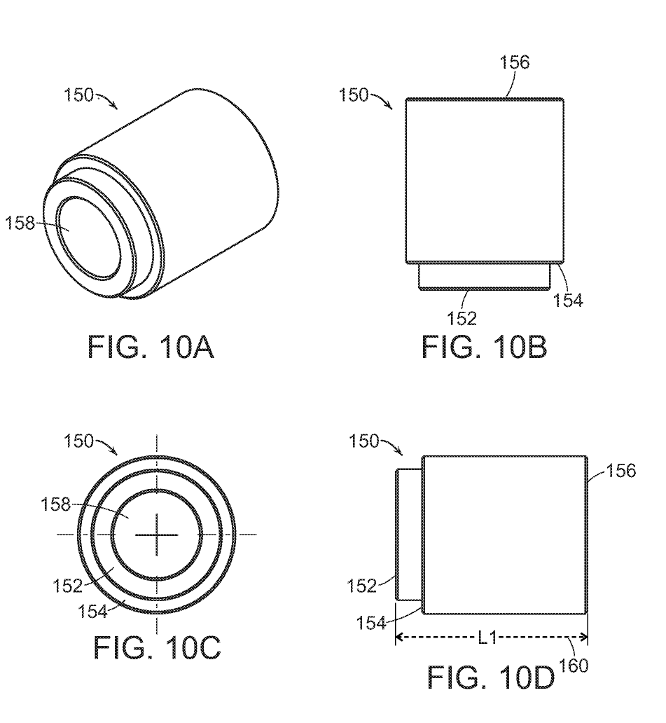

Referring to FIG. 10A-10C, bushing 150 comprises left and right ends 152 and 156, and a hole 158. Left end 152 has an annular recessed portion 154 sized to removably mate and/or engage with recessed portion 116 of mounting hole 114 or recessed portion 120 of mounting hole 118. Bushing 150 has a length (L1) 160 of 0.912 inches. Bushing 150 is made from aluminum by conventional machining operations.

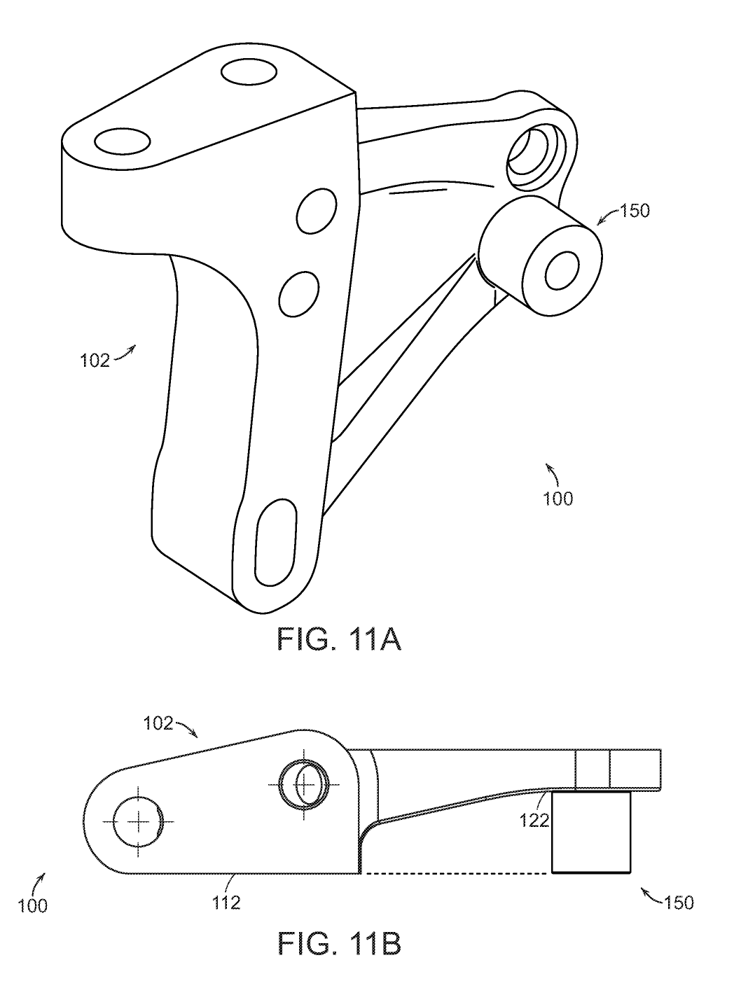

Referring to FIGS. 11A and 11B, where bushing 150 is shown engaged with mounting hole 114. In this position, bracket 102 and bushing 150 may mounted to conventional K20A engine block 10 using mounting holes 114, 124, and slotted hole 128 as shown in FIG. 5. Inner rear mounting surface 112 is set-back a distance from outer rear mounting surface 122. In the embodiment shown, the amount of set-back is equal to the length of bushing 150 less the depth of recessed portion 116 of mounting hole 114, namely, 0.787 inches. It is critical and necessary to the operation of bracket kit 100 that the set-back be at least 0.600 inches. This minimum amount of set-back is needed so that bracket 102 and bushing 150 can be mounted to conventional K20A engine block 12 without interference with sensor 18.

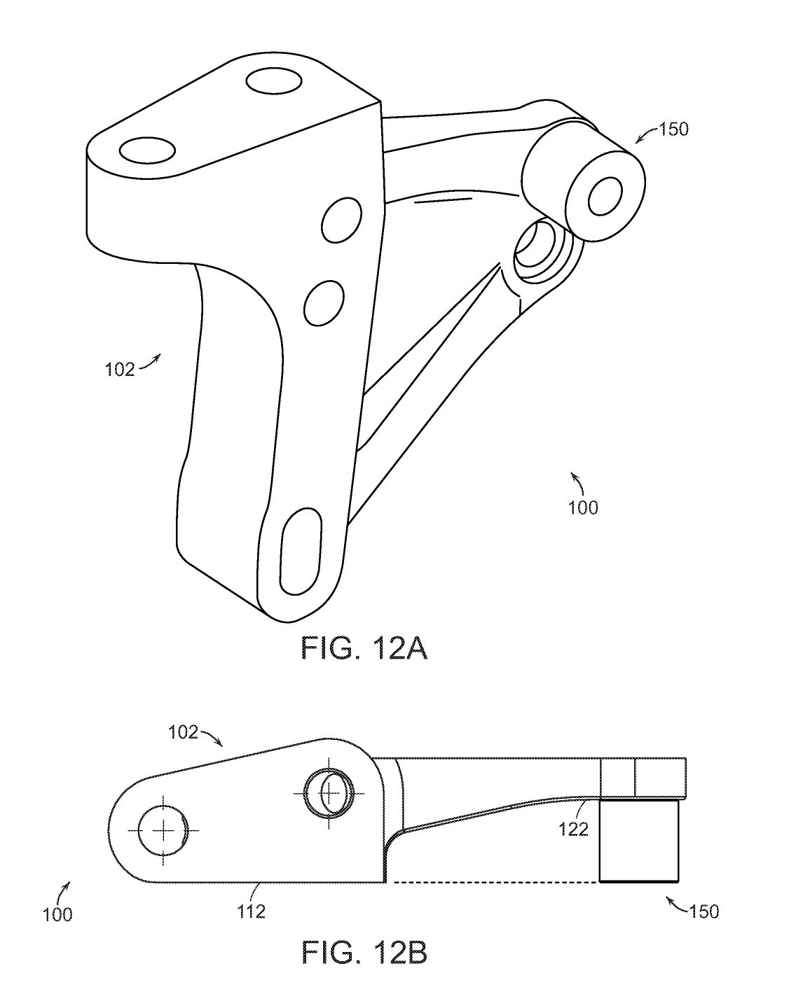

Referring to FIGS. 12A and 12B, where bushing 150 is shown engaged with recessed portion 120 of mounting hole 118. In this position, bracket 102 and bushing 150 may mounted to K24A engine block 20 (FIG. 5) or K24Z engine block using mounting holes 118, 126, and slotted hole 128 (FIG. 6).

While particular embodiments of the invention have been shown and described, it will be obvious to those skilled in the art that changes and modifications may be made without departing from the sprit and scope of the claimed invention.

What is claimed:

1. A bracket kit for mounting an engine mount to first, second, and third engine blocks of different configurations, the bracket kit comprises:
a bracket comprising an upper mounting surface and a hole having a centerline for mounting the engine mount; said centerline of said hole defining a longitudinal axis; said bracket further comprises an inner rear mounting surface and an outer rear mounting surface; said bracket further comprises first and second hole extending to said inner rear mounting surface; said first hole being in close proximity to said second hole; said bracket further comprises first and second recessed portions disposed about said first and second holes, respectively; said bracket comprising third and fourth holes extending to said outer rear mounting surface; said third hole being in close proximity to said fourth hole; said inner rear mounting surface being set back from said outer rear mounting surface; and
a bushing comprising a hole; said bushing may be removably engaged with said recessed portion of said first hole for attaching said bracket to the first engine block; said bushing may be removably engaged with said recessed portion of said second hole for attaching said bracket to the second engine block or the third engine block.

2. The bracket kit of claim 3, wherein said first hole has a centerline positioned in the range of 2.504 to 2.524 (2.514+/−0.010) inches from said upper mounting surface and in the range of 2.733 to 2.753 (2.743+/−0.010) inches from said longitudinal axis.

3. The bracket kit of claim 3, wherein said second hole has a centerline positioned in the range of 1.762 to 1.782 (1.772+/−0.010) inches from said upper mounting surface and in the range of 2.931 to 2.951 (2.941+/−0.010) inches from said longitudinal axis.

4. The bracket kit of claim 3, wherein said third hole has a centerline positioned in the range of 1.741 to 1.761 (1.751+/−0.010) inches from said upper mounting surface and in the range of 0.102 to 0.122 (0.112+/−0.010) inches from said longitudinal axis.

5. The bracket kit of claim 4, wherein said fourth hole has a centerline positioned in the range of 0.998 to 1.018 (1.008+/−0.010) inches from said mounting surface and in the range of 0.077 to 0.097 (0.087+/−0.010) inches from said longitudinal axis.

6. The bracket kit of claim 6, further comprising a slotted hole comprising a first central axis positioned in the range of 3.860 to 3.880 (3.870+/−0.010) inches from said upper mounting surface and in the range of 0.363 to 0.383 (0.373+/−0.010) inches from said longitudinal axis.

7. The bracket kit of claim 6, wherein said slotted hole comprises a second central axis positioned in a range of 4.259 to 4.279 (4.269+/−0.010) inches from said upper mounting surface and in a range of 0.393 to 0.413 (0.403+/−0.010) inches from said longitudinal axis.

8. The bracket kit of claim 7, wherein said set back is at least 0.515 inches.

9. The bracket kit of claim 1, wherein said bracket is made of steel.

10. The bracket kit of claim 1, wherein said bushing is made of steel.
